(19) United States
(12) Patent Application Publication
(10) Pub. No.: US 2005/0027893 A1
(43) Pub. Date: Feb. 3, 2005

(54) Method of controlling high-speed DVI using compression technique and DVI transmitter and receiver using the same

(75) Inventors: Han Jung, Seoul (KR); Chul-Ho Lim, Seoul (KR)

Correspondence Address: Richard S. Milner;Cooper & Dunham LLP, 1185 Avenue of the Americas, New York, NY, 10036, US

(73) Assignee: ED-Tech Co. , Ltd., Seoul (KR)

(21) Appl. No.: 10/892,620

(22) Filed: Jul. 15, 2004

(30) Foreign Application Priority Data
Jul. 30, 2003 (KR) 2003-52833

(51) Int. Cl. G06F 3/00

(52) U.S. Cl. 710/1

(57) ABSTRACT

The present invention relates generally to a method of controlling a high-speed Digital Video Interface (DVI) and digital video interface transmitter and receiver using the method. According to the present invention, it is possible to transmit data between DVI transmitter and receiver at high speed, incorrect operations occurring in the transmission channel are prevented, and hardware for high-speed transmission can be simply implemented.

### BACKGROUND OF THE INVENTION

1. Field of the Invention

The present invention relates generally to a method of controlling a high-speed digital video interface and digital video interface transmitter and receiver using the method, more particularly, to a method of controlling a high-speed digital video interface and digital video interface transmitter and receiver using the method, in which a data compression technique is additionally applied to a digital video interface standard, and data compressed by the data compression technique is transmitted between a digital video interface host device and a display device, so that high-speed data transmission is enabled between the digital video interface host device and the display device. According to the present invention, there are advantages in that the speed of a transmission channel is adaptively controlled, incorrect operations occurring in the transmission channel are prevented, and the amount of hardware used for the high-speed transmission is considerably reduced.

2. Description of the Related Art

A Digital Video Interface (DVI) is a Video Graphics Array (VGA) interface that attracts the highest attention and is expected to have the highest marketability recently. The DVI was developed by a Digital Display Working Group (DDWG) that included a number of companies related to Digital Flat Panel (DFP). Since the transmission method of the DVI adopts a Transition Minimized Differential Signaling (TMDS) protocol such as Plug and Display Digital (P&D-D) and DFP, the compatibility thereof is considerably positive, so that there is a strong possibility that the DVI will be established as a standard. The DVI is designed to provide an improved screen output by digitally transmitting data between a Personal Computer (PC) and a monitor to eliminate a process of converting the digital signal of the PC into an analog signal, which causes the deterioration of image quality. At the beginning, the DVI was developed as a standard for connecting a PC and a monitor. However, the number of home electronic appliances adopting the DVI, such as a digital television, is rapidly increasing, and it is expected that a set-top box and a Digital Versatile Disk (DVD) player will adopt the DVI standard within several years. Furthermore, in the case of the P&D-D and DFP having a single link, the maximum resolution thereof is limited to 1280×1024. However, the DVI has two links, so that the DVI can support more than 1280×1024 resolution by increasing a maximum pixel speed two times. Besides, different from the DFP that can transmit only digital signals, the DVI can transmit not only analog signals but also digital signals, so that the DVI can be applied to an existing analog Cathode Ray Tube (CRT). Accordingly, it is expected that the DVI will be established as a standard for the VGA interface.

The constructions of such a DVI transmitter and a receiver are shown in FIGS. 1 and 2, respectively.

As shown in FIG. 1, a conventional DVI transmitter 100 separates input video data into three Red, Green and Blue (RGB) channels, performs TMDS coding on the input video data and transmits the coded video data to a DVI receiver 200. In this case, each of the channels includes a data capture block 100 for storing input video data until the input video data is processed, a TMDS 8B/10B coder block 120 for coding an 8-bit data signal into a 10-bit transmission data signal required by the DVI standard in response to a 2-bit vertical/horizontal synchronizing signal and a 1-bit data enable signal, and a parallel/serial conversion circuit 130 for converting the coded 10-bit parallel data into serial data for transmission. A differential signal generation block (not shown) is included in the parallel/serial conversion circuit 130, so that an original signal and a reversed signal are output. Furthermore, a swing control logic 140 controls each of the channels so that the output voltage of the channel meets a swing level.

Meanwhile, a conventional DVI receiver 200 also has three channels for receiving and decoding the video data of three RGB channels transmitted from the DVI transmitter 100, respectively, as shown in FIG. 2. In this case, each of the channels includes a data and clock pre-amplifier 210 for amplifying input data before the input data is processed, a data oversampler 220 for oversampling serial data and converting the serial data into, for example, 30-bit parallel data, a data recover 230 for recovering the 30-bit oversampled data to the 10-bit original data, a channel recover 240 for detecting and correcting bit errors, and a channel decoder 250 for decoding the 10-bit data into the 8-bit original data. In this case, the data and clock pre-amplifier 210 includes an input impedance matching circuit (not shown) for accurately recovering the original signal based on the differential signal generated by the parallel/serial conversion circuit 130 of the DVI transmitter 100. Furthermore, the channel recover 240 includes an interchannel sync logic (not shown) for enabling the data individually recovered in the three channels to be accurately synchronized. Furthermore, the conventional DVI receiver 200 further includes a Phase Locked Loop (PLL) 270 for reducing an input clock jitter and generating oversampling clocks, and an output interface logic 280 for interfacing the outputs of the channels with a Liquid Crystal Display (LCD) panel 290.

However, according to the construction of the conventional DVI transmitter and receiver, main function blocks, such as the PLL, and a data processing unit are complicated in proportion to the increase of a data transmission speed. Especially, a more powerful oversampling function is required to enable the DVI receiver 200 to accurately recover high-speed data. That is, when the oversampler 220 of the DVI receiver 200 converts serial data into parallel data by oversampling the serial data, larger bit-number data must be generated. This indicates that the data oversampler 220 and the PLL 270 for generating the oversampling clocks must be complicated. Accordingly, the conventional construction is problematic in that, when the transmission speed increases, costs increase because the circuits are complicated, and, at the same time, stable data recovery is difficult because it is difficult to follow the transmission speed.

### SUMMARY OF THE INVENTION

Accordingly, the present invention has been made keeping in mind the above problems occurring in the prior art, and an object of the present invention is to provide a method of controlling a high-speed DVI using a compression technique.

Another object of the present invention is to provide improved DVI transmitter and receiver, in which the bit rate of each transmission channel is adaptively controlled using the high-speed DVI control method, so that a circuit does not need to be complicated even though a transmission speed increases, thus exchanging data between a DVI host device and a display device at high speed, and preventing incorrect operations generated in a transmission channel.

In order to accomplish the above object, the present invention provides a method of controlling a high-speed DVI using a compression technique, including a DVI transmitter reading video data to be transmitted to a display device, a controller of the DVI transmitter determining a compression ratio of the video data to be transmitted, a 1/N-clock generator reducing a clock frequency, and a compressor of each of channels of the DVI transmitter compressing the video data in proportion to the compression ratio, performing TMDS coding on the compressed data, and transmitting the TMDS-coded data to a DVI receiver, the DVI receiver decoding the TMDS-coded data, a controller of the DVI receiver receiving compression information and transmitting the compression information to a N-clock generator, and the N-clock generator of the DVI receiver recovering a clock frequency to the original frequency, and a recover circuit of each of the channels recovering the compressed data.

In order to accomplish the above object, the present invention provides a high-speed DVI transmitter using a compression technique, including a controller for determining a compression ratio of video data to be transmitted to a display device, a 1/N-clock for generator reducing a clock frequency in proportion to the compression ratio input from the controller, three channels for compressing the video data to be transmitted to the display device with respect to RGB data, respectively, based on the compression ratio input from the controller, performing TMDS coding on the video data, converting parallel data into serial data, and transmitting the serial data to the display device, a swing control logic for controlling the channels to allow each of output voltages of the channels to meet a swing level, and a Phase Locked Loop (PLL) for receiving the clock from the 1/N-clock generator and providing a reference frequency for each of the channels.

In order to accomplish the above object, the present invention provides a high-speed DVI receiver using a compression technique, including a controller for controlling compression release according to compression information received from a DVI transmitter, a PLL for generating oversampling clocks based on clocks received from the DVI transmitter, an N-clock generator for recovering the clocks received from the DVI transmitter to the original clocks under control of the controller, three channels for receiving video data transmitted from the DVI transmitter, performing data recovery and decoding through the oversampling in RGB channels, and releasing the compression of the data based on the clocks of the N-clock generator, and an output interface for providing interface with a display panel to enable the data output from the channels to be transmitted to the display panel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically showing the construction of a conventional DVI transmitter;

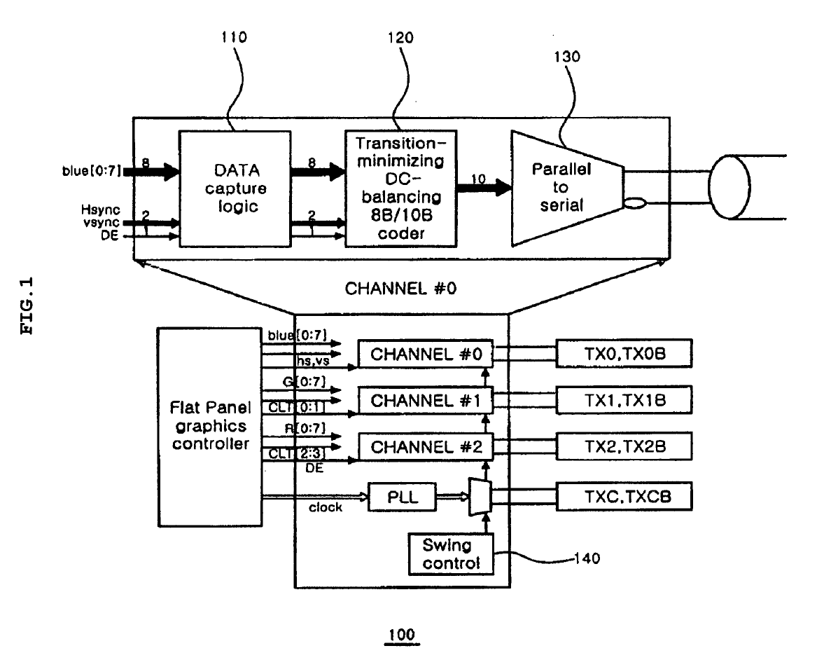

FIG. 2 is a block diagram schematically showing the construction of a conventional DVI receiver;

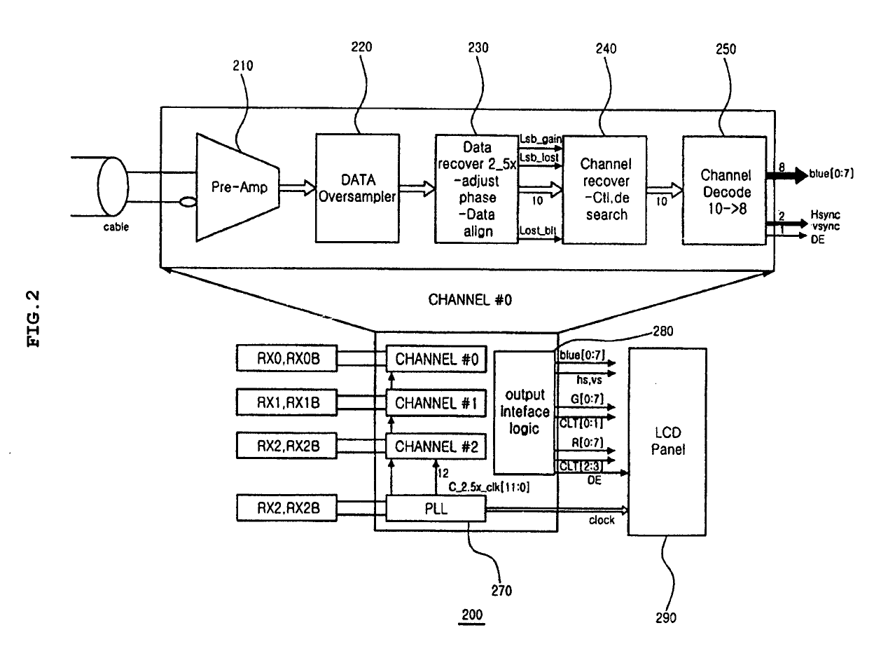

FIG. 3 is a block diagram schematically showing the construction of a DVI transmitter according to the present invention;

FIG. 4 is a block diagram schematically showing the construction of a DVI transmitter according to the present invention;

FIG. 5 is a flowchart showing a process of compressing and transmitting video information in the DVI transmitter of the present invention;

FIG. 6 is a block diagram showing the internal construction of a 1/N-compressor of the present invention; and

FIG. 7 is a block diagram showing the internal construction of an N-recover of the present invention.

### DESCRIPTION OF THE PREFERRED EMBODIMENTS

Reference now should be made to the drawings, in which the same reference numerals are used throughout the different drawings to designate the same or similar components.

The characteristic construction and function of the present invention are described in detail with reference to the attached drawings below.

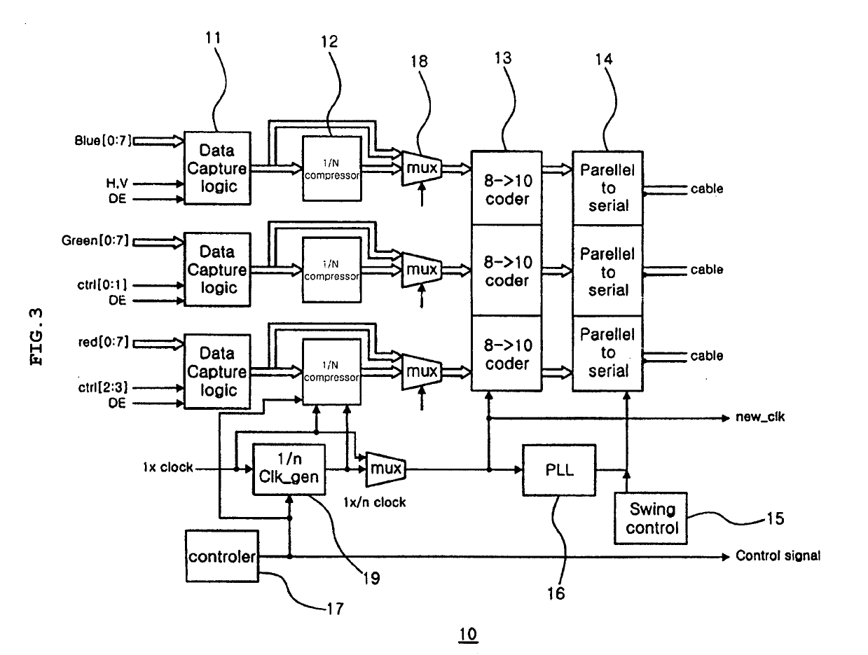

FIG. 3 is a block diagram schematically showing the construction of a DVI transmitter according to the present invention. As shown in FIG. 3, the DVI transmitter 10 of the present invention is identical with the conventional DVI transmitter 100 in that the DVI transmitter 10 separates an input video data signal into three RGB channels, performs TMDS coding on the video data, and transmits the coded data to a DVI receiver 20. However, the DVI transmitter 10 of the present invention is different from the conventional DVI transmitter 100 in that the video data is compressed before the TMDS coding is performed on the video data. In the present invention, each of the channels includes a data capture block 11 for storing input video data until the input video data is processed, a 1/N-compressor 12 for compressing the data at a compression ratio determined by a compression-related parameter input from a controller 17, a Multiplexer (MUX) 18 for switching the compressed data with the original data, a TMDS 8B/10B coder block 13 for coding an 8-bit data signal into a 10-bit transmission data signal, required by the DVI standard, in response to a vertical/horizontal synchronizing signal and a data enable signal, and a parallel/serial conversion circuit 130 for converting the 10-bit coded parallel data into serial-transmission data.

A processing path of transmission data in which a compression process occurs is described below. The controller 17 determines the compression ratio of data, and transmits the information of the compression ratio to the 1/N-compressor 12 and the 1/N-clock generator 19. The 1/N-clock generator 19 generates a clock having a frequency that is compressed by 1/N of the original clock frequency based on the information of the compression ratio, and provides the generated clock to the PLL 16 and the 1/N-compressor 12. The 1/N-compressor 12 compresses the data by 1/N based on the clock, and supplies the compressed data to the TMDS 8B/10B coder block 13. In this case, there may be two ways in which the controller 17 determines the compression ratio of data. One is that a user or manufacturer previously calculates a proper compression ratio in view of the transmission speed of a DVI transmitter and stores the calculated compression ratio in a non-volatile memory. In this case, the controller 17 reads the compression ratio from the non-volatile memory and controls the 1/N-clock generator 19 based on the read compression ratio. The other is a method of adaptively determining a compression ratio according to the transmission speed of a DVI transmitter. That is, if the transmission speed increases, there may be a method of properly increasing the compression ratio in proportion to the increase of the transmission speed. For example, if a transmission speed increases two times, a clock having a frequency that is ½ of a clock frequency required when the transmission speed is doubled is generated instead of the increasing of the compression ratio two times, so that an effect of increasing the transmission speed two times can be achieved with the transmission speed between the DVI transmitter and receiver being uniformly maintained.

Meanwhile, the PLL 16 supplies a stable reference frequency to the parallel/serial conversion circuit 14 of each of the channels with reference to a 1/N clock received from the 1/N-clock generator 19. The parallel/serial conversion circuit 14 converts parallel data into serial data based on the reference frequency and outputs the serial data. In this case, the swing control logic 15 controls the output voltage of the PLL 16 to meet a certain swing level.

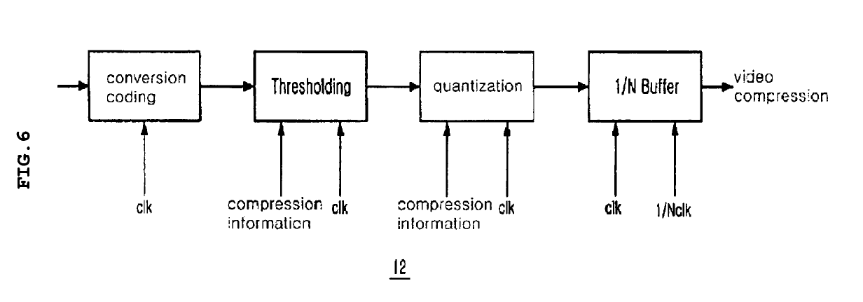

FIG. 6 is a block diagram showing the internal construction of the 1/N-compressor 12 according to the present invention. Like a well-known compressor, the 1/N-compressor 12 shown in FIG. 6 compresses data by eliminating space overlapping caused by the correlations between adjacent pixels.

Various methods of eliminating the space overlapping have been proposed, but a transform encoding method is generally used. The data having passed through a transform encoder undergoes thresholding and quantization processes, and is stored in a buffer. Thereafter, the stored data is transmitted to the TMDS 8B/10B coder block 13 based on the 1/N clock.

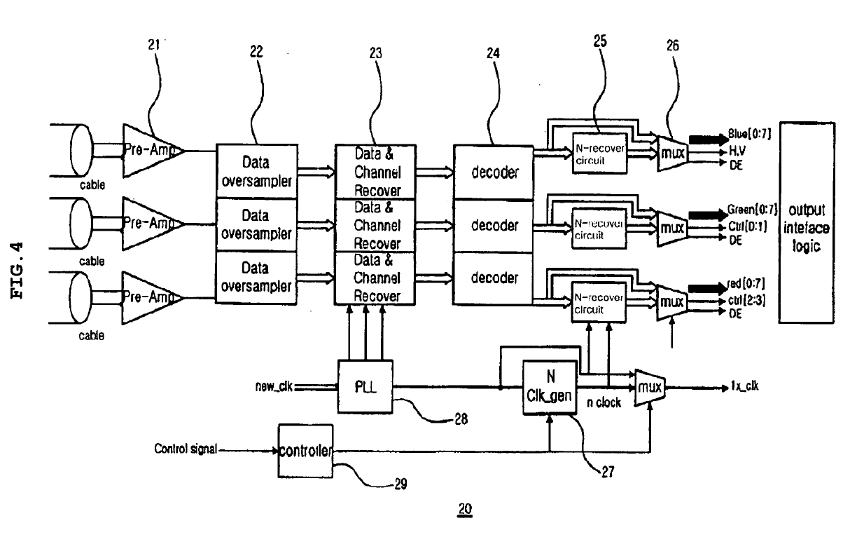

FIG. 4 is a block diagram schematically showing the construction of the DVI receiver 20 according to the present invention. As shown in FIG. 4, like the conventional DVI receiver 200, the DVI receiver 20 of the present invention has three channels for receiving and decoding the video data of the three RGB channels transmitted from the DVI transmitter 10, respectively. The difference between the DVI receiver 10 of the present invention and the conventional receiver 200 is that the DVI receiver 10 of the present invention decodes received data by the TMDS decoder and, thereafter, recovers the data compressed by the 1/N-compressor 12 to the original size of the data. Accordingly, each of the channels of the DVI receiver 20 according to the present invention includes a pre-amplifier 21 for amplifying input data before the input data is processed, a data oversampler 22 for oversampling serial data so that the serial data can be accurately recovered to parallel data, a data & channel recover 23 for recovering the oversampled data to the original TMDS-coded data, detecting and correcting bit errors and synchronizing channels, a channel decoder 24 for decoding the TMDS-coded data, an N-recover circuit 25 for releasing the compression of the 1/N-compressed data and recovering the data to the original data, and a MUX 26 for switching the output of the channel decoder 24 with the output of the N-recover circuit 25.

A process of recovering the data in the DVI receiver 20 is described below. The DVI receiver 20 receives a 1/N clock and a control signal as well as the TMDS-coded and compressed data from the DVI transmitter 10. The control signal includes compression ratio information determined by the controller 17 of the DVI transmitter 10. The controller 29 of the DVI receiver 20 reads the compression ratio information and transmits the information to the N-clock generator 27. The N-clock generator 27 changes the 1/N-clock frequency received from the DVI transmitter 10 at the compression ratio (N times), so that an initial clock frequency is output. The generated clock is provided to the N-recover circuit 25, and the N-recover circuit 25 recovers the compressed data based on the clock.

Meanwhile, the PLL 28 of the DVI receiver 20 of the present invention receives the 1/N clock from the DVI transmitter 10 and transmits the 1/N clock to the N-clock generator 27, and simultaneously generates oversampling clocks with reference to the 1/N clock. The generated oversampling clocks are supplied to the three channels to be used to recover the received data, respectively.

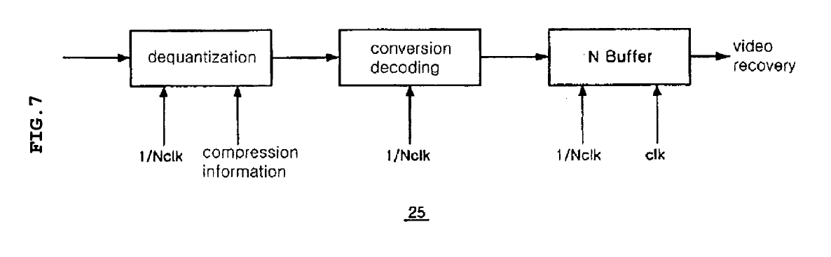

FIG. 7 is a block diagram showing the internal construction of the N-recover circuit 25 of the present invention. As shown in FIG. 7, the N-recover circuit 25 recovers the video data while undergoing an inverse quantization process and a transform decoding process, and achieves video data that is synchronized with a clock while passing through an N-buffer block. In this case, the clock is a clock changed in the N-clock generator as described above.

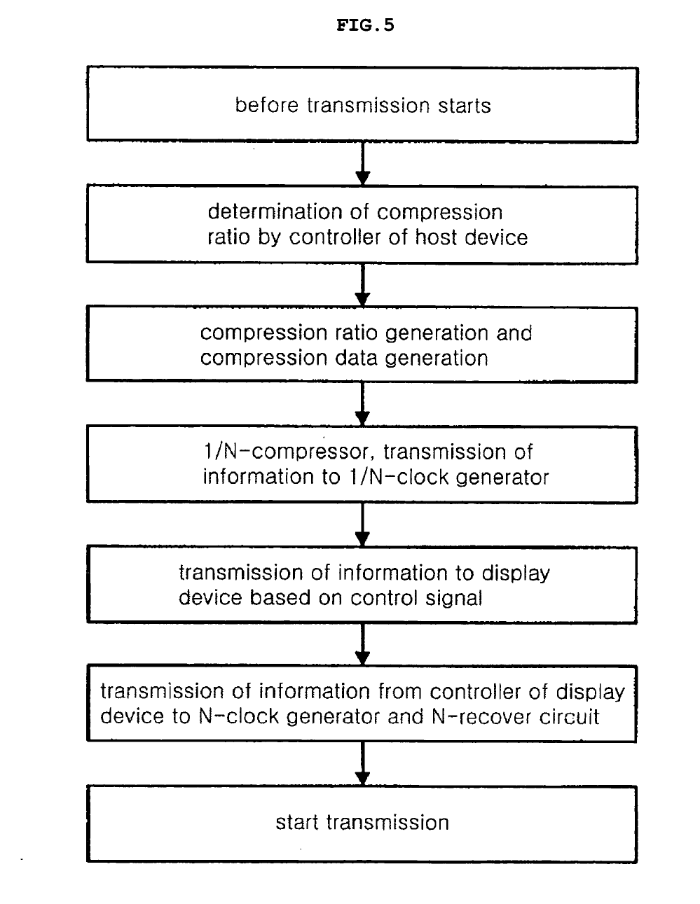

FIG. 5 is a flowchart showing a process of compressing video information in the above-described DVI transmitter and receiver and transmitting the compressed video information. The process is described in brief below. After the DVI transmitter 10 reads video data to be transmitted to a display device, the process is performed in the order of the steps of determining a compression ratio, reducing a clock frequency in proportion to compression ratio, performing the compression and TMDS coding on the video data and transmitting the compressed and TMDS-coded video data to the DVI receiver 20, allowing the DVI receiver 20 to decode the TMDS-coded data, allowing the N-clock generator 27 to recover the clock frequency to the original frequency, and allowing each of the channels to recover the compressed data based on the recovered clock.

The construction and operation of the present invention have been described in detail. As seen from the above description, the present invention adopts a method of compressing data without increasing a physical transmission speed between DVI transmitter and receiver, and provides an effect identical with increasing the transmission speed. Accordingly, it does not need to perform excessive oversampling to achieve to high-speed transmission. Accordingly, by the present invention, it is possible to transmit the data between a DVI host device and a display device at high speed, and incorrect operations generated in a transmission channel can be prevented by adaptively controlling the bit rate of each transmission channel. Furthermore, the amount of hardware required for the high-speed transmission is considerably reduced, so that the present invention is advantageous in that inexpensive DVI transmitter and receiver can be provided.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of controlling a high-speed Digital Video Interface (DVI) using a compression technique, comprising:
a DVI transmitter reading video data to be transmitted to a display device;
a controller of the DVI transmitter determining a compression ratio of the video data to be transmitted;
a 1/N-clock generator reducing a clock frequency, and a compressor of each of channels of the DVI transmitter compressing the video data in proportion to the compression ratio;
performing TMDS coding on the compressed data, and transmitting the TMDS-coded data to a DVI receiver;
the DVI receiver decoding the TMDS-coded data;
a controller of the DVI receiver receiving compression information and transmitting the compression information to a N-clock generator; and
the N-clock generator of the DVI receiver recovering a clock frequency to an original frequency, and a recover circuit of each of the channels recovering the compressed data.

2. The method as set forth in claim 1, wherein the determining of the compression ratio of the data is performed by reading the compression ratio of the data previously input to a memory by a user.

3. The method as set forth in claim 1, wherein the determining of the compression ratio of the data is performed by adaptively increasing the compression ratio in proportion to the transmission speed of the data, so that a bit rate between the DVI transmitter and receiver is uniformly maintained.

4. A high-speed DVI transmitter using a compression technique, comprising:
a controller for determining a compression ratio of video data to be transmitted to a display device;
a 1/N-clock for generator reducing a clock frequency in proportion to the compression ratio input from the controller;
three channels for compressing the video data to be transmitted to the display device with respect to each of Red, Green and Blue (RGB) data, respectively, based on the compression ratio input from the controller, performing TMDS coding on the video data, converting parallel data into serial data, and transmitting the serial data to the display device;
a swing control logic for controlling the channels to allow each of output voltages of the channels to meet a swing level; and
a Phase Locked Loop (PLL) for receiving the clock from the 1/N-clock generator and providing a reference frequency for each of the channels.

5. The DVI transmitter as set forth in claim 4, wherein the controller reads a compression ratio of data previously input to a memory by a user and determines the compression ratio.

6. The DVI transmitter as set forth in claim 4, wherein the controller adaptively increases the compression ratio in proportion to a transmission speed of the data to uniform a bit rate between the DVI transmitter and a DVI receiver.

7. The DVI transmitter as set forth in claim 4, wherein each of the channels comprise:
a data capture block for storing input video data until the input video data is processed;
a 1/N-compressor for compressing the video data based on the compression ratio input from the controller;
a TMDS 8B/10B coder block for performing TMDS coding on the compressed data; and
a parallel/serial converter for converting the coded parallel data into transmission serial data.

8. The DVI transmitter as set forth in claim 7, wherein the channel further comprises a Multiplexer (MUX) for switching the data compressed in the 1/N-compressor with original data without passing through the compression.

9. A high-speed DVI receiver using a compression technique, comprising:
a controller for controlling compression release according to compression information received from a DVI transmitter;
a PLL for generating oversampling clocks based on clocks received from the DVI transmitter;
an N-clock generator for recovering the clocks received from the DVI transmitter to original clocks under control of the controller;
three channels for receiving video data transmitted from the DVI transmitter, performing data recovery and decoding through the oversampling in RGB channels, and releasing the compression of the data based on the clocks of the N-clock generator; and
an output interface for providing interface with a display panel to enable the data output from the channels to be transmitted to the display panel.

10. The DVI receiver as set forth in claim 9, wherein each of the channels comprise:
a pre-amplifier for amplifying the input data;
a data oversampler for oversampling serial data and converting the serial data into parallel data;
a data recover for recovering the oversampled data to original coded data;
a channel recover for detecting and correcting bit errors, and synchronizing the channels;
a channel decoder for performing TMDS decoding; and
an N-recover circuit for releasing the compression of the decoded and compressed data.

11. The DVI receiver as set forth in claim 10, wherein the channel further comprises a MUX for switching the data whose compression is released in the N-recover circuit and the data whose compression is not released.
